(19) United States
(12) Patent Application Publication
(10) Pub. No.: US 2003/0028428 A1
(43) Pub. Date: Feb. 6, 2003

(54) System, method, and computer program product for selectively displaying internet advertisements

(75) Inventors: Gregory Maurice Plow, Gilroy, CA (US); Farrokh E. Pourmirzaie, San Jose, CA (US)

Correspondence Address: John L. Rogit, Rogitz & Associates, Suite 3120, 750 B Street, San Diego, CA, 92101, US

(73) Assignee: International Business Machines Corporation, Armonk, NY (US)

(21) Appl. No.: 09/922,201

(22) Filed: Aug. 2, 2001

(51) Int. Cl. G06F 17/60

(52) U.S. Cl. 705/14

(57) ABSTRACT

A system and method for selectively displaying Internet advertisements includes allowing a user to establish the values of user definable attributes. Internet advertisements are then transmitted to the user computer based on the user definable attributes. Also, user selectable advertisement channels are provided. A user can, accordingly, select an advertisement channel and only advertisements corresponding to that channel are displayed.

### TECHNICAL FIELD

The present invention relates generally to Internet advertisements.

### BACKGROUND OF THE INVENTION

In recent years, the Internet has been expanding at a furious pace. One reason for the rapid expansion of the Internet is the popularity of the free services that are available thereon. A company can fund free or reduced cost services on the Internet with revenue generated from advertisers. As a particular website increases in popularity and the viewer traffic increases, advertisers become more likely to increase their advertising budget in order to reach the growing audience.

Unfortunately, there exists a potential problem with the above-described business model that threatens to undermine the rapid expansion of the Internet. Specifically, this problem relates to the ineffectiveness of displaying numerous advertisements (“ads”) that are not appealing to individual consumers. In other words, Internet advertisers cannot guarantee that particular consumers are viewing ads that they find interesting. Consumers may simply “tune-out” or ignore Internet ads in which they are not interested. Moreover, regardless of the aggressiveness with which advertisers bombard consumers, many consumers can become increasingly jaded with Internet ads and less likely to notice the plethora of ads because they grow weary of being inundated with what they might feel is useless and irrelevant information.

Advertisers have attempted to tailor their ads to individual consumers by using various “data mining” solutions. For example, when an individual user is using a search engine, a targeted ad may appear which is in the same or similar category as the user's search term. In other words, if a user searches the Internet using the phrase “golf course,” he or she may receive a series of ads related to golf vacations, golf supplies, golf equipment, etc. While this approach has value over simply displaying random ads to random Internet users, it does not guarantee that the user has an interest in the genre of ads that are displayed based on the search words. In the above example, the user may have been a grass seed salesperson with zero interest in golf.

### SUMMARY OF THE INVENTION

Having recognized the above drawbacks, the present invention provides the solutions noted below to one or more of them.

A method for selectively displaying Internet advertisements includes allowing a user to define advertisement attributes. Advertisements are then displayed based on the user defined attributes. Advertisements that do not correspond to the user defined attributes are filtered out of the advertisements transmitted to the user computer. In a preferred embodiment, a menu of user definable attributes is displayed. A user is allowed to establish the values of the user definable attributes. The attributes can include: advertisement type, city, zip code, retailers, distance of travel to a retailer, means for delivery, retail only, or wholesale only.

Also, in a preferred embodiment, a menu of advertisement channels is displayed. A user is allowed to choose an advertisement channel from the menu. Advertisements that correspond to the advertisement channel are then displayed. On the other hand, advertisements that do not correspond to the advertisement channel are filtered out of the advertisements transmitted to the user computer. The advertisement channels can include: a travel channel, a food channel, an automotive channel, a clothing channel, a music channel, a movie channel, an antiques channel, a hardware channel, a sporting goods channel, a housewares channel, an art supplies channel, etc. Preferably, a user is allowed to create an an advertisement window in which the advertisements are displayed. Moreover, the advertisements are displayed at a device that receives Internet content and television broadcast content.

In another aspect of the preferred embodiment of the present invention, a system for selectively displaying Internet advertisements includes a server, a database connected to the server, and a user computer connected to the server via an Internet connection. The database stores plural Internet advertisements that the server transmits to the user computer. Moreover, the user computer includes a program for selectively displaying Internet advertisements.

In yet another aspect of the preferred embodiment of the present invention, a computer program device includes a computer readable means. The computer readable means selectively displays Internet advertisements and includes logic means for allowing a user to define attributes. Also, the computer readable means includes logic means for displaying advertisements at least partially based on the user defined attributes.

In still another aspect of the preferred embodiment of the present invention, a method for viewing advertisements on a computer system includes selecting an attribute in an advertising window in which advertisements are displayed. Then, a series of advertisements are viewed in the advertising window. Each advertisement within the series embodies the selected attribute.

The present invention will now be described, by way of example, with reference to the accompanying drawings, in which:

### BRIEF DESCRIPTION OF THE DRAWINGS

FIG. 1 is a block diagram of a system architecture;

FIG. 2 is a flow chart of the operating logic of the preferred embodiment of the present invention;

FIG. 3 is a view of a computer screen;

FIG. 4 is a flow chart of an alternate embodiment of the operating logic of the preferred embodiment of the present invention; and

FIG. 5 is an alternative view of a computer screen.

### DESCRIPTION OF AN EMBODIMENT OF THE INVENTION

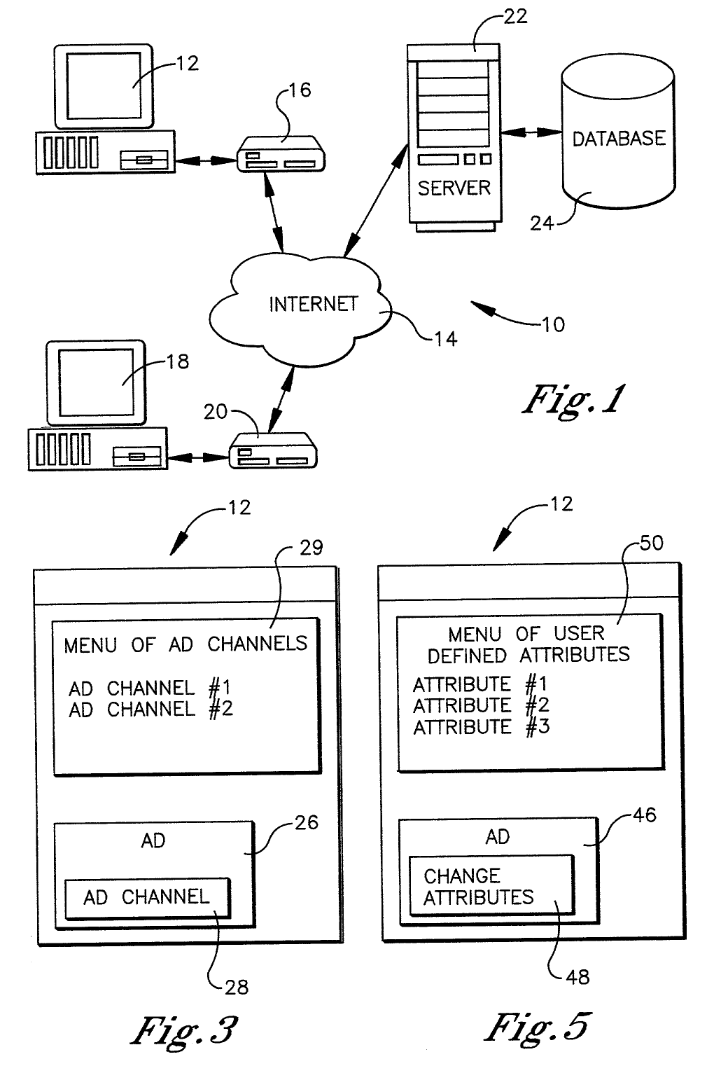

Referring initially to FIG. 1, a system is shown and generally designated 10. As shown in FIG. 1, the system 10 includes a first user computer 12 connected to the Internet 14 via a first modem 16. FIG. 1 also shows a second user computer 18 connected to the Internet 14 via a second modem 20. It can be appreciated that the modems 16, 20 can be telephone modems, cable modems, DSL modems, etc. that provide connections to the Internet 14 by telephone line, television cable, LAN, WAN, Ti, or any other means well known in the art.

As shown in FIG. 1, a server 22 is also connected to the Internet 14. The server 22, in turn, is connected to a database 24. The server 22 transmits user requested information stored in the database 24 to the user computers 12, 18 via the Internet 14. In many cases, along with the information, the server 22 transmits advertisements (“ads”) to the user computers 12, 18. These ads help defray the cost of providing the information, services, etc. to the users. Thus, the users can receive much information available on the Internet 14 for no fee or for a nominal fee. It is to be appreciated that numerous servers can be connected to the Internet to provide information and services to the user computers on a nearly infinite range of subjects

While the preferred implementations of the user computers 12, 18 are personal computers manufactured by International Business Machines (IBM), the computers 12, 18 can be any computers, including Unix computers, or OS/2 servers, Windows NT servers, or laptop computer. (Unix is a registered trademark of The Open Group in the United States and other countries. OS/2 is a registered trademark of International Business Machines Corporation in the United States, other countries, or both. Windows NT is a trademark of Microsoft Corporation in the United States, other countries, or both.) Additionally, the computers 12, 18 can be hand held computers or any other devices that receive Internet content. Each user computer 12, 18 includes a series of computer-executable instructions, as described below, which will allow the user computer 12, 18 to only receive ads of a particular interest to the user.

The instructions may be contained in random access memory (RAM) within each computer 12, 18 or on a data storage device with a computer readable medium, such as a computer diskette. Or, the instructions may be stored on a magnetic tape, conventional hard disk drive, electronic read-only memory (ROM), optical storage device, or other appropriate data storage device or transmitting device thereby making a computer program product, i.e., an article of manufacture according to the invention. In an illustrative embodiment of the invention, the computer-executable instructions may be written, e.g., using C++.

The flow charts herein illustrate the structure of the logic of the present invention as embodied in computer program software. Those skilled in the art will appreciate that the flow charts illustrate the structures of computer program code elements including logic circuits on an integrated circuit, that function according to this invention. Manifestly, the invention is practiced in its essential embodiment by a machine component that renders the program elements in a form that instructs a digital processing apparatus (that is, a computer) to perform a sequence of function steps corresponding to those shown.

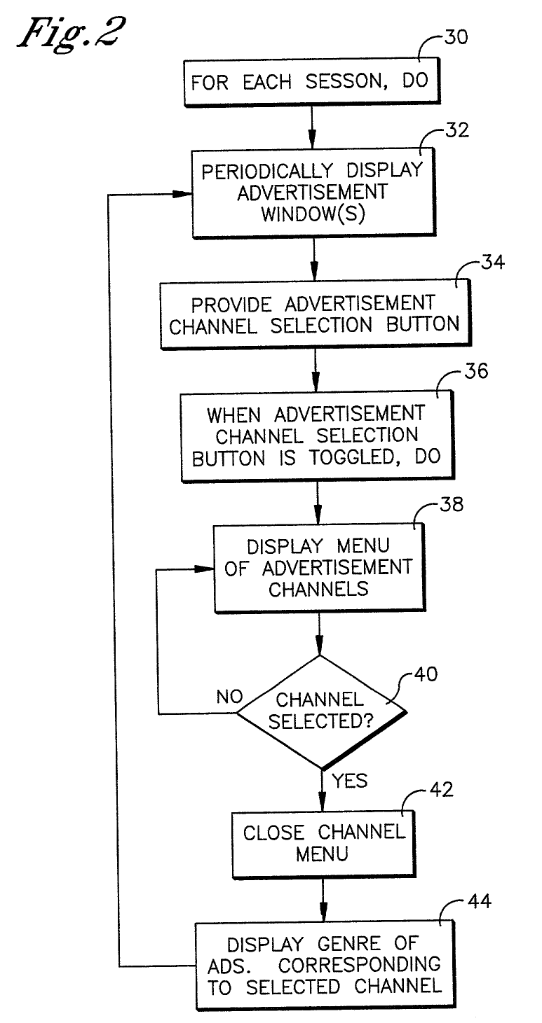

Referring to FIG. 2, the operating logic of the present invention is shown and commences at block 30 with a do loop, wherein for each user Internet session, the succeeding steps are performed. At block 32, at least one ad 26 (FIG. 3) is periodically displayed at 136 the user computer 12. Moving to block 34 an “Ad Channel” button 28 (FIG. 3) is provided to the user at the user computer 12. The “Ad Channel” button 28 can, e.g., be presented within the same window as the ad 26 or in the frame of the browser. Thereafter, at block 36 an internal do loop is entered wherein when the “Ad Channel” button 28 is toggled, the following steps are performed.

At block 38, a menu 29 of ad channels (FIG. 3) is displayed when the “Ad Channel” button 26 is toggled. In a preferred embodiment, the menu 29 of ad channels is provided by the browser. Proceeding to decision diamond 40, it is determined whether a channel has been selected by the user. If not, the menu 29 of ad channels continues to be displayed. If a channel is selected, the logic continues to block 42 where the channel menu 29 is closed. Then, at block 44 the genre of ads corresponding the user selected channel is displayed. If at any time while the user is online, and he or she toggles the “Ad Channel” button 28, the menu 29 of ad channels is displayed. It is to be understood that the menu 29 of ad channels can include: a travel channel, a food channel, an automotive channel, a clothing channel, a music channel, a movie channel, an antiques channel, a hardware channel, a sporting goods channel, a housewares channel, an art supplies channel, etc.

Thus, while the user is working he or she can choose which types of ads should be displayed at his or her computer. For example, if the user is interested in purchasing a new automobile, he or she can choose an ad channel that corresponds to automobiles, e.g., the automotive channel, and only ads relevant to cars will be displayed while he or she is working. The individual ads are tagged using HTML tags so that the server is able to identify which ads correspond to which channels and only transmit to the user computer 12 those ads which are tagged in accordance with the user's preferred channel.

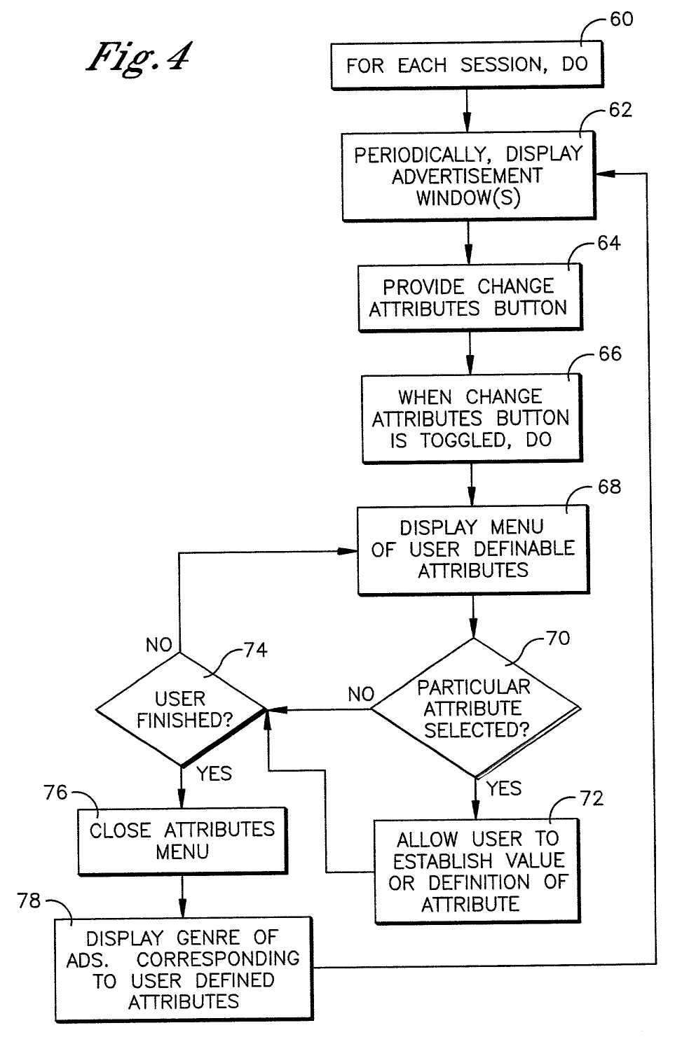

Referring now to FIG. 4, an alternative embodiment of the operating logic is shown and commences at block 60 with a do loop wherein for each user Internet session the following steps are performed. At block 62, at least one ad 46 (FIG. 5) is periodically displayed at, e.g., the first user computer 12. Moving to block 64, a “Change Attributes” button 48 (FIG. 5) is provided. This button 48 can, e.g., be presented in the same window as the ad 46 or in the browser frame.

Thereafter, at block 66 an internal do loop is entered wherein when the “Change Attributes” button 48 is toggled, the succeeding steps are performed. At block 68, when the “Change Attributes” button 48 is toggled, a menu 50 (FIG. 5) of user definable attributes is displayed. Continuing to decision diamond 70, it is determined whether a particular attribute is selected by the user. If so, the logic moves to block 72 where the user is allowed to establish the value or definition of that particular attribute. Next, the logic proceeds to decision diamond 74 where it is determined whether the user is finished changing the attributes. If so, the user definable attributes menu 50 is closed at block 76 and then, at block 78, the genre of ads corresponding to the user defined attributes is displayed at the user computer 12.

If, at decision diamond 74, the user is not finished changing the attributes, the logic returns to block 68 where the display of the user definable attributes menu 50 is continued. Returning to decision diamond 70, if a particular attribute is not selected, the logic continues to decision diamond 74 and continues as described above.

It is to be understood that the user defined attributes include, but are not limited to, the user's city, the user's zip code, the user's preferred retailers, the user's preferred distance of travel to a retailer, the user's preferred means for delivery, whether the user is interested in retail or wholesale, advertisement types, etc. For example, if a user defines a particular city in the user definable attributes menu, only ads from retailers located in that city, as indicated by HTML tags on the ads, will be displayed. Thus, the user's Internet session takes on a local feel.

It is also to be understood that in each method described above, if ads cannot be found that exactly match a user's preferred channel or a user's defined attributes, the server will make a “best effort” attempt to match the user's preferences and send ads that closely match the user's preferences. Moreover, in each method described above there can be multiple ad windows displayed at the computer 12 simultaneously. Thus, a user can, e.g., view ads corresponding to the sporting goods channel and the automotive channel at the same time. Also, the ad windows 26, 46 described above can be automatically established by the browser or, in the alternative, they can be created by the user, e.g., to define the size, shape, position, etc., thereof.

Further, although the above-described methods are defined the context of computer systems, it is to be understood that they can be applied to interactive television systems that receive internet content as well as television broadcast content.

While the particular SYSTEM, METHOD, AND COMPUTER PROGRAM PRODUCT FOR SELECTIVELY DISPLAYING INTERNET ADVERTISEMENTS as herein shown and described in detail is fully capable of attaining the above-described objects of the invention, it is to be understood that it is the presently preferred embodiment of the present invention and thus, is representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it is to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. section 112, sixth paragraph, unless the element is expressly recited using the phrase “means for.”

1. A method for selectively displaying Internet advertisements, comprising the acts of:
allowing a user to define advertisement attributes; and
displaying advertisements at least partially based on the user defined attributes.

2. The method of claim 1, further comprising the act of:
allowing the user to create an advertisement window in which advertisements are displayed.

3. The method of claim 1, further comprising the act of:
displaying a menu of user definable attributes.

4. The method of claim 3, further comprising the act of:
allowing the user to establish the values of the user definable attributes.

5. The method of claim 3, wherein the user definable attributes include at least one of: advertisement type, city, zip code, retailers, distance of travel to a retailer, means for delivery, retail only, or wholesale only.

6. The method of claim 1, further comprising the act of:
displaying a menu of advertisement channels.

7. The method of claim 6, further comprising the act of:
allowing a user to choose at least one advertisement channel.

8. The method of claim 7, further comprising the act of:
displaying at least one advertisement corresponding to a user selected advertisement channel.

9. The method of claim 7, wherein the menu of advertisement channels includes at least one of: a travel channel, a food channel, an automotive channel, a clothing channel, a music channel, a movie channel, an antiques channel, a hardware channel, a sporting goods channel, a housewares channel, or an art supplies channel.

10. The method of claim 1, wherein the advertisements are displayed at a device that receives Internet content and television broadcast content.

11. A system for selectively displaying Internet advertisements, comprising:
at least one server;
at least one database connected to the server, the database storing plural Internet advertisements; and
at least one user computer connected to the server via an Internet connection, the server transmitting plural Internet advertisements to the user computer, the user computer including a program for selectively displaying Internet advertisements.

12. The system of claim 11, wherein the program comprises:
logic means for allowing a user to define attributes; and
logic means for displaying advertisements at least partially based on the user defined attributes.

13. The system of claim 11, wherein the program further comprises:
logic means for displaying a menu of user definable advertisement attributes.

14. The system of claim 13, wherein the program further comprises:
logic means for allowing the user to establish the values of the user definable advertisement attributes.

15. The system of claim 13, wherein the user definable attributes include:
advertisement type, city, zip code, retailers, distance of travel to a retailer, means for delivery, retail only, or wholesale only.

16. The system of claim 11, wherein the program further comprises:
logic means for displaying a menu of advertisement channels.

17. The system of claim 16, wherein the program further comprises:
logic means for allowing a user to choose at least one advertisement channel.

18. The system of claim 17, wherein the program further comprises:
logic means for displaying at least one advertisement corresponding to a user selected advertisement channel.

19. The system of claim 16, wherein the menu of advertisement channels includes at least one of: a travel channel, a food channel, an automotive channel, a clothing channel, a music channel, a movie channel, an antiques channel, a hardware channel, a sporting goods channel, a housewares channel, or an art supplies channel.

20. The system of claim 11, wherein the program further comprises:
logic means for allowing the user to create an advertisement window in which advertisements are displayed.

21. The system of claim 11, further comprising:
at least one television connected to the server via an Internet connection, the server transmitting plural Internet advertisements to the television, the television including a program for selectively displaying Internet advertisements.

22. A computer program device, comprising:
a computer readable means having logic means for selectively displaying Internet advertisements, comprising:
logic means for allowing a user to define attributes; and
logic means for displaying advertisements at least partially based on the user defined attributes.

23. The program device of claim 22, wherein the computer readable means further comprises:
logic means for displaying a menu of user definable attributes.

24. The program device of claim 23, wherein the computer readable means further comprises:
logic means for allowing the user to establish the values of the user definable attributes.

25. The program device of claim 23, wherein the user definable attributes include:
advertisement type, city, zip code, retailers, distance of travel to a retailer, means for delivery, retail only, or wholesale only.

26. The program device of claim 22, wherein the computer readable means further comprises:
logic means for displaying a menu of advertisement channels.

27. The program device of claim 26, wherein the computer readable means further comprises:
logic means for allowing a user to choose at least one advertisement channel.

28. The program device of claim 27, wherein the computer readable means further comprises:
logic means for displaying at least one advertisement corresponding to a user selected advertisement channel.

29. The program device of claim 26, wherein the menu of advertisement channels includes at least one of: a travel channel, a food channel, an automotive channel, a clothing channel, a music channel, a movie channel, an antiques channel, a hardware channel, a sporting goods channel, a housewares channel, or an art supplies channel.

30. A method for viewing advertisements on a computer system, comprising the acts of:
selecting at least one attribute in an advertising window for displaying advertisements; and
viewing in the advertising window at least one of a series of advertisements corresponding to a selected attribute, wherein each advertisement within the series embodies the selected attribute.

31. The method of claim 30, wherein the attribute is selected from the group consisting of: advertisement type, city, zip code, retailers, distance of travel to a retailer, means for delivery, retail only, wholesale only, and advertisement channel.
